(19) United States
(12) Patent Application Publication
(10) Pub. No.: US 2007/0061141 A1
(43) Pub. Date: Mar. 15, 2007

(54) Anti-terrorism interoperable radio communications

(76) Inventor: Richard G. Johnson, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/486,445

(22) Filed: Jul. 13, 2006

Related U.S. Application Data
(60) Provisional application No. 60/787,299, filed on Mar. 30, 2006.
(60) Provisional application No. 60/708,932, filed on Aug. 17, 2005.
(60) Provisional application No. 60/709,019, filed on Aug. 17, 2005.
(60) Provisional application No. 60/698,687, filed on Jul. 13, 2005.

(51) Int. Cl. G10L 17/00

(52) U.S. Cl. 704/246; 705/22

(57) ABSTRACT

A method for interoperable radio communications including the steps of: a) at least one radio user's transmitting at least one transmission on a first radio frequency to a computer having at least one sound card and at least two sound card channels on one or more sound cards, wherein each of the at least two sound card channels is programmed to receive and process transmissions from at least two separate radio frequencies; b) the radio user's posting a transmission as either a sound recording or a transcribed voice or data file to a folder or other record on the computer; and c) at least a second radio user's transmitting and/or receiving, on a second radio frequency via a sound card channel, to or from the same or another folder on the same or a different computer.

### CROSS REFERENCE TO RELATED APPLICATIONS

This application claims priority to U.S. Application No. 60/787,299, filed Mar. 30, 2006; to U.S. Application No. 60/708,932, filed Aug. 17, 2005; to U.S. Application No. 60/709,019, filed Aug. 17, 2005; and to U.S. Application No. 60/698,687, filed Jul. 13, 2005, each of which is incorporated herein by reference.

### BACKGROUND OF THE INVENTION

1. Field of the Invention

The invention pertains to restoring communications before and during terrorist threats or acts or in emergencies, and focuses on making heretofore non-interoperable radio systems (such as Police, Fire, Hazmat, etc.) interoperable even under attack or emergency conditions (when such interoperability is most needed).

2. Description of Related Art

In a disaster scene, it is typical to find two types of devices. First, radios are plentiful. Second, computers are available. It has been this inventor's mission to invent new ways of interconnecting radios and computers to provide data transfer, and data management systems, for regional disasters. Traditionally, amateur radio has been a fertile ground for new technology development. Since the 1940s, numerous products including cellphones, developed from amateur radio, have been commercialized. The importance of radio technology in providing communications during emergencies is evident today in such events as the earthquake and tsunami in December of 2004, and the Sep. 11, 2001 attack. As reported in The Wall Street Journal, “With Hurricane Katrina having knocked out nearly all the high-end emergency communications gear, 911 centers, cellphone towers and normal fixed phone lines in its path, Amateur Radio Operators have begun to fill the information vacuum. In an age of high-tech, real-time gadgetry, it's the decidedly unsexy “ham” radio—whose narrow audio bandwidth has changed little since World War II—that is in high demand in ravaged New Orleans and environs.”

Narrow-band battery operated radios work well when others do not because they are simple and readily available in disaster scenes. This inventor's solutions transmit data quickly and reliably over those radios, leveraging both the ubiquitous legacy equipment and the expansive network of voice-based radio repeaters that are already deployed nationwide.

The greatest problem facing further development in emergency radio communications is the problem of interoperability. Because different radio systems operate on different frequencies, they are not by nature interoperable. The result is simple and inevitable: radios on different frequencies cannot communicate with each other.

The traditional solution to this particular interoperability problem is a device known as an interoperability bridge. In its simplest terms, an interoperability bridge is a switchboard that either manually or physically connects two or more frequencies together. Although this solution is viable and in some circumstances works well, it has a significant drawback. Once two frequencies, or more than two frequencies, are interconnected through the interoperability bridge, spoken voice communications (known as traffic) on one frequency are automatically placed simultaneously on all other frequencies interconnected by the interoperability bridge. This consumes valuable airtime on all frequencies, making the standard traditional interoperability bridge solution unacceptable in threat situations, emergencies or disasters, when heavy traffic turns into a literal radio traffic jam.

### SUMMARY OF THE INVENTION

In order to avoid such communications traffic jams and to render truly interoperable radio communications using two or more frequencies, the present invention is a method for interoperable radio communications including the steps of: a) at least one radio user's transmitting at least one transmission on a first radio frequency to a computer having at least one sound card and at least two sound card channels on one or more sound cards, wherein each of said at least two sound card channels is programmed to receive and process transmissions from at least two separate radio frequencies; b) said radio user's simultaneously or subsequently posting, via the preprogrammed computer, said transmission as either a sound recording or a transcribed voice or data file obtained from the received transmission to a folder on the computer; and c) at least a second radio user's transmitting and/or receiving, on a second radio frequency via a sound card channel, to or from the same or another folder on the same computer, to enable said at least two users to transmit and/or receive messages from said computer via said first and second radio frequencies. If the computer folders are periodically replicated on more than one computer by separate radio transmission, each radio user may transmit to the same or a different computer. Any user may be human or robotic (or a combination of human action and robot or other automated equipment) either to transmit or to receive messages.

Stated a little differently, a way to understand a core feature of the present invention is that it is method for interoperable radio communications, comprising: a) providing a computer having at least one sound card and at least two sound card channels; b) configuring said at least two sound card channels to receive transmissions from at least two separate radio frequencies; programming the computer to receive transmissions to the sound card channels and further programming said computer to post either sound recording or transcribed voice or data files obtained from a received transmission via the sound card channels to a folder on the computer; and making the folder accessible by radio communication to a user operating a radio on one of the at least two frequencies.

### DESCRIPTION OF THE PREFERRED EMBODIMENT(S)

For a focused, effective, and rapid response to a regional disaster, the portable emergency radio communications operator must have clear strategies to establish reliable interoperable bridges between radio systems that can operate either simultaneously or concurrently, and which can both “push” and “pull” data. The present invention describes just such an approach, using the “Inverse Scanner Interoperability Bridge” using ARMS™ and Tone63™” to provide interoperability.

This invention builds upon four previous inventions of this inventor, namely, MDT™, ARMS™, Porta-Browser™, & Tone63™, and this specification assumes familiarity with those inventions. The following U.S. patent applications are all hereby incorporated herein by reference to that end: U.S. Application No. 60/787,299, filed Mar. 30, 2006; U.S. Application No. 60/708,932, filed Aug. 17, 2005; U.S. Application No. 60/709,019, filed Aug. 17, 2005; U.S. Application No. 60/698,687, filed Jul. 13, 2005; U.S. Application No. 60/679,958, filed May 11, 2005; U.S. Application No. 60/679,615, filed May 10, 2005; U.S. Application No. 60/636,761, filed Dec. 16, 2004; U.S. Application No. 60/574,963, filed May 27, 2004; and U.S. application Ser. No. 11/137,115, filed May 25, 2005. The following introduces six additional interrelated technologies by first describing them, and then showing how their integrated operation solves formerly unsolvable emergency radio interoperability communications dilemmas: Part One—“Addressing Via Speech Recognition” [“AVSR™”]; Part Two—“Frequency Allocation Multiplexing” [“FAM™”]; Part Three—“Inverse Scanner Interoperability Bridge63” [“ISI-Bridge63™”]; Part Four—“A Method for Automatic Collection of Weather Data Using Tone63™ & MDT™ Nodes” [“NWS MDT™ Node-based Auto-Attendant”]; Part Five—“A Method for Transmitting, Managing, and Replicating Sensor Data Using Tone63™ & MD™ Nodes” [“Sensor Node Net—“Porta-Sensor”]; and Part Six—“Power in Emergency Radio Communications” [“Portable Power-Sink”].

Part One—Addressing Via Speech Recognition (History of Using Tones for Control and Voice as the Data)

There is a long-standing, prior art tradition in the electronics community of using tones as a way of controlling data in voice format. For example, early slide projectors used cassette tapes to control not only the advance from one slide to another, usually through a system of tones in the left channel, but also data in voice format in the right channel. Similarly, modern telecommunications systems employ the same basic technique. Cellphones, for example, are controlled by a series of control tones not audible to the user, addressing and directing the location of the data, which data is the voice content. For Addressing Via Speech Recognition (AVSR™), however, the opposite occurs, namely, using speech as the control information, and passing tones, digital material or more voice as data. For example, when a user logs into the ARMS™ system, the system uses AVSR™ to associate the user with a folder. Similarly, Porta-Browser™ associates the user's identity (i.e., the user's Incident Command Structure function) with html or xml files in that user's folder. ISI-Bridge63™ uses the AVSR™ function of ARMS™ to associate the user's frequency and soundcard with a specific folder on the (non-Internet) server.

Stated another way, AVSR™ broaches what Alvin Toffler called the Fourth Wave, or the synergistic combination of electronic computers with biochemical life. Addressing Via Speech Recognition (AVSR™) is actually a confluence of a computer with a uniquely biological phenomenon—speech, and more particularly, the unique speech of a unique speaker. AVSR™ is more than voice recognition (speech recognition) technology already known in the art, therefore. AVSR™ provides a computing—including computer-enabled communications—function by virtue of its biological element and the ability of a voice to identify the speaker. “Speech-print” generation is a completely noninvasive realization of a Fourth Wave innovation. Whereas a person can be identified by their fingerprints, retinal scans or DNA (with the respective consequences of blackened fingers, retinal laser exposure or tissue sample collection), when a person is individually identified to a computer by the person's voice, the person remains as biologically intact as after any other time the person happens to speak normally. As can be understood better upon consideration of all that follows, the biological interface of a user's speech's not only creating the AVSR™ commands, but also identifying the AVSR™ user, means that biological function and computing technology are Fourth-Wave-juxtaposed. It should be noted that AVSR™ is not the vocal equivalent of tapping a computer keyboard with the fingers—a user's voice never touches the keys or a computer in any way, at least in a tangible physical way. Even beyond this, though, AVSR™ is not generic to possible users or usurpers, so whereas anyone's fingers can tap a computer keyboard and the computer does not know who is tapping, AVSR™ in context does actually identify the individual user. In the context of using an ARMS™ server, for example, (that is, interactive voice mail for radio described in one of the patent applications incorporated herein by reference), even if an imposter can get away with saying “Activate ARMS™ Service” and getting a “Please log in” prompt, subsequent actions of the system will betray the user as an imposter if he or she is not the enrolled (speech-recognition program already trained by him or her) user. In a recorded version of an imposter's voice message, the recipient can easily identify that the voice of the speaker is not of whom the speaker purports, and thus the biologically unique interface serves its purpose. If the message version is text or computer voice replayed via speech recognition transcription, taken from the transmission of an imposter into the account/folder of an enrolled user (whose speech recognition profile has already been trained), the message will have a uniquely distinctive garbled nature that occurs when an untrained or other-trained speech recognition program is subjected to a human voice, for which the program was not trained, that says more than a few common words. This distinctive garble identifies the transmission or message as having been made by an imposter, and AVSR™ thus performs an identification and security function. The phenomenon of imposter-revelation by the combination of AVSR™ and either speech recognition transcription of the radio transmission or message, or voice-recording and replaying of the radio transmission or message, establishes a unique interface between biological users and computers, which Fourth Wave interface as “speech print” appears to be unprecedented.

In summary, then, AVSR™ is the act of commanding of a computer, either locally or by voice radio communication (preferably narrow band), by use of human speech which both directs a data transmission (which follows subsequently and which, without limitation, may be either a tone or a further human voice or computer voice transmission) and which identifies the computer user to the computer by his or her unique speech patterns.

Two different ways of stating some of these ideas include the following. This portion of the present invention is a method of establishing the individual identity of a computer user to a computer, comprising a) programming a computer to recognize the speech of at least one user, followed by b) the addressing of data by the at least one user's speech to and/or from the computer, wherein due to the addressing via speech recognition the computer can distinguish said at least one user from a different user. In a similar vein, the invention is also a method of establishing the identity of a recipient of information, comprising a) programming a computer to recognize the speech of at least one user, followed by b) the addressing of data by the at least one user's speech to and/or from the computer, wherein due to the addressing via speech recognition, the computer can designate the intended recipient of the information. In this way, it can be seen that the user identification function of AVSR™ is effective both as to the transmitting user as well as to the receiving user, even though the identification takes place a little differently (see above description of “distinctive garble” and etc.)

Part Two—Frequency Allocation Multiplexing

Tone63™ ordinarily uses its full bandwidth (usually narrowband) to update one folder (as described above) at a time, in situations where the radio traffic is high. Should multiple folders need to be updated simultaneously, Tone63™ uses frequency allocation multiplexing (FAM™), as described below, to update all of the folders at once. Normally, Tone63™ uses 64-tone channels of QPSK-FEC spread both temporally (FEC) and spatially (over its 2 kHz or 3 kHz bandwidth). When FAM™ is invoked, Tone63™ divides its bandwidth by the number of simultaneous folders that require to be updated, and defines its resources accordingly. This division takes place using DSP, digital signal processing, applying the appropriate pass band filters, PBF, to the proportional subset of the Tone63™ signal. In the example set forth below, Tone63™ would use FAM™ to send five separate multiplexed channels, each one of the five consisting of 12-tone channels of QPSK-FEC (approximately 64/5 rather than one 64-tone channel), which is reconstructed and placed into the addressed folder by the recipient's computer just as though it received the five transmissions serially. Although FAM™ will cause Tone63™ to update each folder proportionately slower, overall, the system will be completely self replicated very quickly and automatically. If Tone63™ is used after addressing with AVSR™, the voice command does the addressing of the computer and the text or other data content is sent by tone thereafter (in contrast with a voice message addressed by tones as occurs in telephony and elsewhere).

Part Three—Inverse Scanner Interoperability Bridge (ISI-Bridge63™)

When a voice or other sound file—locally or by radio transmission—can address a computer, and data records can be sent by tones or other means governed by the voice or other sound addressing, such pieces can fit into an inverse scanner interoperability bridge (ISI-Bridge63™) that makes it feasible for the first time for a plurality of radio operators to transmit on different frequencies and yet all be able to communicate with one another without traffic jams. Generally speaking, at a central computer to which all the radio transmissions and radio receptions desired to be interoperably available are received, either by designated radio receivers on each frequency or by software defined radio for each frequency, the central computer is configured with at least one sound card or sound card channel for each such frequency. By way of the sound card or sound card channel, each transmission may be “heard” by the computer and either transcribed (by speech recognition software, ideally trained to the voice of the specific user) or recorded by wave or mp3 or similar file, followed by posting to an e-mail database, spreadsheet or web-page type file. In other words, each transmission is created in the user's folder and is posted, generally but not necessarily by speech addressing, to the stated recipient's folder, typically using voice commands. In practice, such posted transcribed or recorded messages are much more like traditional radio messages than answering machine messages because each radio user can receive a message waiting tone or indicator while using his or her radio, and immediately direct (via voice addressing, usually) that the waiting transcribed or recorded message be played. The real-time effect of this system is very much like a radio repeater (or store and forward device), in that the recipient waits for and, in this case, prompts, the repetition of a previously transmitted message for the recipient to hear. The entire process can happen so fast, when desired, that in many cases the exchanging of messages can be, but need not be, virtually a real time conversation when the messages adhere to standard radio net format. The advantage of having the option of the recipient's hearing the message when the recipient is ready for it, and recalls or plays the message on command, is that the messages can be reordered as to priority (see below) and will never assault the recipient more than one at a time, which can and does happen in purely real time radio communications.

After it is understood that the ISI-Bridge63™ is a comprehensive system of folders on a centralized computer in which messages can be posted and retrieved to users' folders on an almost instantaneous basis and/or at will, it is easy to see that the ISI-Bridge63™ enables the comprehensive system of folders to substitute for a real-time, net-control directed radio net in such a way as to remove traffic problems. Radio users who wish to hear their messages can hear a computer voice generated rereading of their messages at the time the messages are retrieved, and/or can replay actual voice messages. For example, in a terrorist response setting (and see the below example as well) individual users will have Fire, Police, Hazmat, etc. responsibilities. As messages from Fire and Police are sent to the Hazmat individual, using this system the Hazmat individual does not have to hear them all in real time—the Hazmat individual listens to the messages serially as the Hazmat individual retrieves them, and no message “walks” over any other due to multiple transmissions on the same frequency. Even more importantly, the user can prioritize the messages he or she wishes to hear first by assuming that message priority will approximate the identity of the user. So, for example, any radio user will preferentially retrieve the Incident Commander's messages first, in an emergency, due to the status and likely importance of the sender's message due to the sender's identity. Ironically, at this writing e-mail recipients use sender-based prioritizing all the time when reviewing e-mail messages, but the controllable, sender-based prioritizing (and at will reordering or selecting of) of radio messages is new to the present invention.

While it is certainly possible to bridge a great number of different frequencies together using this new technology, for the purposes of a nonlimiting example, consider an interoperability bridge for five frequencies:

(1) Incident Command;

(2) Police;

(3) Ambulance 1;

(4) Ambulance 2; and

(5) Fire

First, look at a detailed list of the components and functions required of an ISI-Bridge63™: 1. One server (no Internet connection required); and 2. Five soundcards (one soundcard for each channel to be made interoperable). Next, look at the overall general functionality of the ISI-Bridge63™. 3. Using AVSR™, each frequency is associated with an ARMS™ (or Porta-Browser™) Folder. 4. Any registered or enrolled user can activate ARMS™ from any AVSR™ associated frequency. 5. Once activated, the user can send an ARMS™ message as:

a General Bulletin;

a message targeted to a group, e.g., “Ambulance 2;”

a voicemail;

an email (or SMS, MMS, ICQ, & c, assuming there is an Internet connection); or

any combination of the above.

6. Once the communication has been sent, AVSR™ associates the recipient or recipients with it or its soundcard, and causes a distinctive tone to sound on the recipient's or recipients' frequency. 7. The alert tone can be preceded by another user-configurable tone, such as may be required to activate a tone squelch or other system activation sound. 8. A short .mp3 or .wav recording may sound instead of the alert tone, for example, a recording saying “Message from the Incident Commander” (the recording may be digitally accelerated computer voice font, optimized for high speed intelligibility and distinctiveness). 9. The alert tone is specific, allowing the recipient(s) to identify by tone the identity of the sender. 10. The alert tone beacons on a regular basis, to ensure that it is heard despite other traffic that might be present on the recipient frequency. 11. Upon hearing the beacon alert, any recipient can activate ARMS™ and:

Retrieve the voice bulletin(s);

Retrieve the MDT™ E-text/email Bulletin (enrolled users only);

Retrieve voice messages;

Reply to voice messages;

Retrieve MDT™ E-text/email messages (enrolled users only); and/or

Reply to MDT™ E-text/email messages via MDT™ or voice (enrolled users only).

12. No Internet connection is required; if one is available, then electronic communications over the Internet are possible. 13. Users can also send and receive non critical messages, i.e., messages placed on the system by the sender as normal rather than priority. 14. Non-critical messages do not invoke the beaconing alert function. 15. For each frequency user's folder, whenever a new priority message appears, the computer alerts the frequency by beaconing to its dedicated soundcard. 16. Tone63™ data and data files may similarly be left and retrieved as voice messages, allowing data transfer, data storage, and data retrieval within the disaster scene. 17. Having multiple soundcards monitoring and beaconing to specifically assigned frequencies allows the system dynamically to work with any new or existing radio system (simplex, repeater, trunked, or other) that may subsequently appear in the disaster areas. 18. If a radio from the frequency or talk group user is available, then that radio is simply interfaced with the sound card. 19. If such a radio is not available, then a general coverage receiver may be substituted, if a suitable one is available.

. . . Use of Software Defined Radio. Ideally, there will be an SDR (“Software Defined Radio) associated with each sound card that can quickly be programmed to act as the frequency or talk group user using that channel, obviating the need for user equipment, or general coverage receivers (scanners). Because only the sender's channel is used during the send message stage, the use of scarce airtime is absolutely minimized. The recipient's or recipients' frequency is not used or activated until such time as there is a message waiting (which may be a request for information).

Because it is possible that the main ISI-Bridge63™ computer may be compromised, the system is designed to be self replicating. Even though no Internet connection is used, the various computers (“Nodes”) self replicate in such a way that anyone has the capability of taking over the main control command functions when so directed. This is accomplished by interconnecting the nodes together by radio using Tone63™ on an unused frequency. In other words, from time to time some or all the folders on a given computer may be transmitted via radio, and duplicated, on a separate computer.

In all the aspects of the present invention, not just the technology of this Part, any information or message posted and ready for receipt by a recipient may be “alerted” to the recipient by any audible, visual or other alert. Such an alert, without limitation, could be a beep or tone, or could be a speech prompt or any other audible or visual—or even tactile, such as a vibration—sensable event. (If future technology makes it possible, the alert could even be something the user could smell or taste.) The point of the alert is to make the recipient aware that there is a transmission awaiting receipt. The alerts can be priority based, so that, say, only sender-based priority designated messages are alerted to the recipient. The alerts can be sender-specific, such as a message from the Incident Commander's being alerted to the recipient, on the frequency the recipient is monitoring, with a real voice or computer voice generated prompt that literally says, maybe even very quickly, “INCIDENT COMMANDER.” After the message from the Incident Commander (or other sender by extension—this is a single nonlimiting example), the alert can be programmed to stop.

Part Four—A Method For Automatic Collection of Weather Data Using Tone63™ & MDT™ Nodes

This is a proposal to automate the National Weather Service Skywarn weather data collection program by using advanced technology described herein. Using this technology, the National Weather Service can automatically receive high quality, filtered, screened, and formatted actual live weather reports without having to dedicate a forecaster or Amateur Radio Station Operator. This technology uses an automatic computer and cutting edge software instead, creating an “Auto-Attendant” for NWS Skywarn data.

Although the National Weather Service has access to some of the most modern technology available, for accurate weather reports, it still relies upon situation reports from people in the weather area. Advanced technology cannot always report actual ground conditions. Most National Weather Service “Warnings” are issued based upon reports from people rather than from projections from technology.

Obtaining and managing actual reports from people, however, creates problems and expenses for the National Weather Service. The NWS must assign a person to collect, filter, and evaluate the various reports to the exclusion of other activities.

Because the need for actual live reports is so acute, the NWS has adopted the strategy of obtaining reports in two general ways. In some cases, situation reports are solicited from a person in the affected area, using various techniques for identifying the person.

But a primary way that the NWS obtains live situation reports is through the “Skywarn” program. The Skywarn program is a system of trained weather observers who send in coordinated situation reports either by telephone or by Amateur Radio. Throughout the year, the NWS holds community training programs designed to qualify Skywarn Observers by training them how to observe weather phenomena, what weather reports the NWS desires, and how to report the observations by telephone or by Amateur Radio.

Amateur Radio is of particular assistance to the NWS because the reports going to the NWS office from Amateur Radio are very high quality. The reason that Amateur Radio weather reports are so high in quality is because of how the Amateur Radio community “filters” the situation reports of weather conditions.

Under the Amateur Radio community culture, radio usage and reports are almost always coordinated by a Moderator or Parliamentarian called in radio parlance a “Net Control Station [NCS].” The Net Control Station is a person that directs the usage of the frequency by recognizing operators, recording key reports, and requesting specific information using well-established radio parliamentary procedure.

Normally, when the National Weather Service issues a weather watch, trained Amateur Radio Skywarn observers begin to watch the weather and listen to the previously assigned Skywarn Amateur Radio frequency within the Amateur Radio band. When the NWS issues a Warning, then a Net Control Station will activate a Skywarn Net. The Net Control Station can be activated by the NWS (usually by way of a radio or cellphone call), or can self-activate (i.e., certain Amateur Radio Operators who frequently serve as Net Control can, on their own initiative, activate a Skywarn Net).

Once the Skywarn net is active, the Net Control solicits weather situation reports from the Amateur Radio Operators in the affected area. Some of these operators will be at home, but many will give their reports from their automobiles, as they pass through more or less weather activity.

The Net Control Station will invariably be a well-trained Skywarn Observer, and is fully capable of filtering the incoming reports. The Net Control Station will know what weather situations to report to the NWS, and which ones not to report (e.g., the NWS desires reports of rainfall in excess of one inch per hour, but not whether roadway surfaces have simply become wet). In some situations, the reporting Amateur Radio Operator will be over-eager to report weather information not desired by the NWS (e.g., wet roads), and the Net Control Station can suppress this extraneous data by not reporting it.

The information collected by the Net Control Station makes its way to the NWS office in one of several ways. In some situations, a NWS employee serves as the Net Control Station form the NWS's Amateur Radio Station, but this is an expensive and resource demanding undertaking. In other situations, a volunteer Amateur Radio Operator will contemporaneously travel to the NWS office and staff the station during the weather event. In both of these situations, the filtered weather data arrives to the NWS via radio through a person staffing the NWS's Amateur Radio Station.

More often than not, the Net Control Station is not located at the NWS office, so the filtered reports arrive at the NWS through either a NWS employee operating the NWS Amateur Radio Station, or by a call to a special telephone number at the NWS. In some cases, the Net Control Station emails the filtered reports to the NWS office.

The Skywarn Amateur Radio reporting system is an outstanding program, but is presently facing of number of specific problems. First, the proliferation of cellphone usage has caused a decline in Amateur Radio activities, and so there are significantly fewer Skywarn Amateur Radio Operators giving reports in the first place. Second, there has been a marked decline in the number of Amateur radio Operators who are willing and able to staff the NWS office during a weather emergency.

Therefore, the National Weather Service is receiving fewer and fewer filtered Skywarn weather situation reports from Amateur Radio Net Control Stations, and instead is relying more and more upon either unfiltered reports or specifically solicited reports, requiring more and more NWS human resources.

The present technology solves these two problems using a new, cutting edge, proprietary procedure, in an automated speech-recognition based solution.

For example, a weather emergency approaches. As the National Weather Service issues a Warning, the SAME (known in the art) signal activates numerous weather radios in the affected area. At the National Weather Service office, the Amateur Radio Station now includes (in addition to an aerial, feedline, and Amateur Radio) a computer and a computer/radio soundcard interface device. The computer, normally in standby mode, responds to the SAME signal, and activates both the computer and the Amateur radio.

Throughout the affected area, numerous Amateur Radio Operators both base and mobile, turn on their radios and prepare to send weather situation reports. An experienced Skywarn trained Operator takes the initiative and activates a Skywarn Net.

As the Amateur Radio Operators give their reports to the Net Control Station, the Net Control Operator carefully records the NWS reportable data, either onto his laptop computer or else simply onto a piece of paper.

When a significant reportable event occurs and comes to the attention of the Net Control Station, the Net Control Operator pauses the net, and briefly switches to the simplex frequency allocated by agreement to NWS reporting.

The Net Control Station now calls the National Weather Service's Amateur Radio Station, which has been equipped with the NWS Auto-Attendant and programmed using software to respond to certain words spoken over the radio by the Net Control Station. The frequency chosen may be any simplex Amateur Radio frequency, and might be on the Six-Meter band.

Once the software is activated by the Net Control Station, the NWS Station responds by asking the Net Control Station to “log-in.” The Net Control Station (along with a number of trusted and active Amateur Radio Operators) have previously been entered as authorized users in the NWS Auto-Attendant computer, and the computer has been trained to recognize their voices.

Therefore, the Net Control Station may log-in, invoking advanced speech recognition technology or tone based or other data transmission such as Tone63™ technology, and allowing the NWS Auto-Attendant computer to transcribe what the Net Control Operators says or to decode the Tone63™ digital file. The Net Control Station now reads over the radio on the simplex frequency the weather situation reports just collected over the Skywarn net.

If the Net Control Station recorded his reports on a computer, then the procedure can be a little bit different. Using the “Text Reading” feature of the system's product, the Net Control Station logs into the NWS Auto-Attendant Radio Computer using a computer voice, called a “data optimized voice-font”. This is a computer generated voice that has been optimized to maximize its intelligibility to the receiving computers speech-recognition feature, and which has been extensively trained to allow for high speed, high reliability data transfer. In other words, the information read by the transmitting computer over the radio is transcribed with an extremely high level of accuracy and the NWS Auto-Attendant Radio receiving computer.

The NWS Auto-Attendant Radio computer transcribes—word for word—the filtered Skywarn reports, date & time stamps the reports, and stores them in html format on a “NWS Auto-Attendant” Browser Page (not Internet related) on the local computer. The NWS Auto-Attendant Radio computer may be remote, and itself replicated at any other location using Tone63™ or other data transmission as described above.

The NWS forecaster who desires to see these reports may access the reports at whim during the warning period or anytime thereafter in a number of ways. First, the forecaster may simply walk over to the NWS Auto-Attendant, click on one or more of the Browser page, and read or print the data from the browser page. Or, should networking be appropriate, the forecaster may view the page over the network.

After a preset time, the NWS Auto-Attendant Radio computer automatically stores all of the Browser Pages, clears the screens, and powers down the radio and computer.

As an automated APRS-based solution, and as an additional “add-on,” the invention can interface the NWS Auto-Attendant program with the existing APRS system of automated weather reporting. This provides to the NWS Auto-Attendant a source of contemporaneous weather reports in the absence of commercial power, internet, and telephone service.

APRS, or “automated position reporting system,” is a network of radios and Digipeaters which was initially devised to report (voluntarily) the location of an Amateur Radio Station. By using a GPS (Global Positioning System) receiver attached to an Amateur Radio transmitter, the Station's location is transmitted using packet radio.

APRS has the ability to transmit a small amount of additional data in addition to the GPS coordinates. A common use of this excess capacity is weather data.

The APRS system can therefore be a source of filtered weather situation reports. As an example, imagine that a local radio club (e.g., the Skyview Radio Society) has the necessary equipment to receive APRS weather data. An Operator reviews the APRS weather information, and extracts the reportable data. This filtered data is the placed into a file in preparation for transfer to the NWS Auto-Attendant.

The Skyview Operator accesses the NWS Auto-Attendant just as the Net Control Station does. The Operator transmits the filtered weather data by using the data-optimized voice-font. The NWS forecaster receives the filtered weather situation reports just as before.

Costs for the NWS Auto-Attendant include a standard Amateur Radio system (aerial, feedline, radio, power supply) which is often pre-existing. Added to the System are two devices: a standard desktop or laptop computer, and a computer/radio audio interface device. The only additional cost is the software.

Part Five—A Method for Transmitting, Managing, and Replicating Sensor Data Using Tone63™ & MDT™ Nodes

There is a plethora of sensors covering thousands and thousands of square miles not only in the United States, but also throughout the world. These sensors measure everything from temperature and weather information to locations and seismic activity.

Despite being ubiquitous, it is nevertheless a grand challenge to obtain the data from these various sensors (which are often located in remote areas far from commercial power, internet, telephone, and cellphone services). Also, even when collected, there is no good way of organizing the data from multiple sensors in a way that can be easily viewed by a person needing the data. And finally, there is no good existing way to replicate the data collected at one point to a backup node located away from an area where the data collection point might be compromised.

This system solves the problems of sensor data collection and management by providing low-power sensor data acquisition, low-power data transmission, and replicable node-based data management in the absence of commercial power, internet, telephone, and cellphone services.

Here are the individual components of the Porta-Sensor™ system, and how Porta-Sensor™ works (imagine a sensor somewhere in a desolate location):

The Porta-Sensor™ uses a solar cell to obtain electricity from sunlight, and a simple charge controller to regulate the charge voltage and current to a battery of either NiMH or Pb cells, serving as a power sink. The same power source could be used to power the sensor itself.

Data from the sensor is intercepted by a self contained PIC (Programmable Interrupt Controller), and depending upon the character of the telemetry, is converted to simple numeric data by an EEPROM specifically flashed to convert the particular semantics of the sensor at hand.

The converted data from the EEPROM then excites a DSP (Digital Signal Processor) chip, which produces sound in the form of an optimized digital voicefont (E-Vox), consuming exceptionally little power to do so. Through this process, the sensor data has been transformed into a sequence of numbers and delimiters appropriate to the database form in use, and the sequence of numbers and delimiters (i.e., in the case of an Excel™ comma separated value worksheet, numerals and commas) has been converted to optimized speech in the form of an optimized data voicefont. In other words, the sensor data is now speech.

The speech generated by the DSP is absolutely uniform in character, and has an extremely limited vocabulary, i.e., numerals, possibly hexadecimal characters, and the database delimiter (probably a comma). The generated speech has also previously been used to train a speech-recognition program to recognize the optimized data voicefont. Because of the absolute consistency of the optimized data voicefont, and the limited extent of the generated vocabulary, the speech recognition software can recognize the generated speech at extremely high speed.

The speech generated by the DSP, being wholly within a standard audio bandwidth, is now coupled to a standard transmitter, modulated as either FM or SSB (depending on the transmission range required), and then transmitted on a frequency and at a power level appropriate to the range to the receiver.

The data collection point consists of a standard radio receiver coupled to a computer pre-loaded with speech-recognition software which has been especially trained to recognize the DSP optimized data voice-font. The signal received by the radio is a sequence of “spoken” numerals and delimiters, which are converted by the speech-recognition software back into their native data format, stored to the hard disk, and then are available for viewing by, in this case, Excel™.

This same data can be managed at the data collection point by using an html-based file system. The html system will not be connected to the internet under this example, but under appropriate circumstances it certainly could be. Browsers like Internet Explorer™ are ideal for data management, because they are readily available, and require little if any training to use.

The data collected from the sensor will have a unique identifier included in it when transmitted. This identifier not only identifies the sensor to the data collection point, but also signals the speech recognition software where to store the file. In this example, the file will be stored in a folder or directory previously established to be associated with the source sensor. The Excel™ file, readable as a “DDE” link to Internet Explorer™, is stored in that sensor's folder.

The previously established “website” has on its main page, in an organized way appropriate to the sensor net being viewed, links to the various sensors, which can then be viewed upon request. The end user can now see the data from the sensor, and no additional software nor training is required.

The system described can easily be replicated. The “Data Collection Point” is in reality nothing more than an aerial, a radio receiver, a computer audio interface, and a computer. There can be more than one data collection point (“Nodes”) simply by having similar setups anywhere within the range of the sensors' transmitters. In the event that a primary node were to be disabled, another node can seamlessly take over the primary data collection duties. Thus, this system is not only simple, it is self-replicating.

As a first alternative, Porta-Sensor™ can operate using a system of tones (Tone63™) instead of the optimized data voicefont, as follows:

The converted data from the EEPROM will still excite a DSP (Digital Signal Processor) chip, which produces sound instead of speech, in the form of Tone63™, a proprietary QAM-FEC-based digital mode of communications using at maximum a 3k audio bandwidth, consuming exceptionally little power to do so. In other words, the sensor data is now coherent, forward error correcting tones, being wholly within a standard audio bandwidth.

The data collection point consists of a standard radio receiver coupled to a computer pre-loaded with Tone63™-recognition software, which quickly & accurately discerns the data being transmitted, even under extremely adverse reception conditions, including dropouts.

This data can be managed at the data collection point exactly as described above, using the same html-based management scheme; the system here described can also easily be replicated.

As a second alternative, the Porta-Sensor™ system can operate using any power source. As a third alternative, the Porta-Sensor™ system can operate over any audio channel, either wired or wireless, including any available modulation scheme. As a fourth alternative, the Porta-Sensor™ system can send audio signal over non-traditional audio channels, such as string, wood, metal, and other vibrating materials. As a fifth alternative, the Porta-Sensor™ system can send audio over non-traditional audio modulation channels, such as modulated coherent infrared light, modulated coherent light, modulated incoherent light, and over any other medium that can be modulated at audio bandwidths.

Part Six—Power in Emergency Radio Communications

For a focused, effective, and rapid response to a regional disaster, the portable emergency radio communications operator must have clear strategies to obtain, transport, use, and replenish power. This Method describes just such an approach to power management.

The most elegant power source is the sun. Solar cells [most commonly amorphous silicon crystals] are efficient, rugged, and can be selected by considering parameters such as voltage, size, current, and weather worthiness. An emergency radio operator should select a cell with the capacity to replenish 1.5 times the usage of the radio equipment over a 5-7 day time period, under cloud cover for approximately 50% of the time.

The solar cell should be mounted in a weatherproof way, and where it will be exposed to the maximum sunlight or illumination possible. The solar cell can be mounted between glass, Plexiglas, plastic, Lexan, or any other sturdy clear material.

The connection to the charge controller should use large enough wire to overcome transmission losses, and should include fuses for over-currents, metal-oxide varistors for TVSS (transient voltage surge suppression), and gas-discharge tubes for fast-acting TVSS.

Because the solar cell produces unregulated voltages which can easily exceed amounts that can damage a battery, the power system uses a charge controller. The charge controller allows only proper charge voltages to reach the battery, draws its own power only from the solar cell, prevents insufficient voltages from reaching the battery, prevents excessive currents and voltages from overcharging the battery. A good charge controller will also monitor the state of charge of the battery, and will appropriately apply current or voltage as required for each of the four charging stages, i.e., Bulk (Constant Current, 14.2-15.0 VDC up to 80% Capacity), Absorption (Constant Voltage 14.4 VDC to 95% Capacity), Equalization (Constant Current (C10) to provide final 5%), and Float (Constant Voltage 13.2-13.6 VDC). The “State of Charge” [“SOC”] percentage can be measured by interrupting the charging process (for five to ten seconds every two minutes) to allow for sensing of the resting voltage. The “State of Charge” measurement is easily accomplished because there is a linear relationship between voltage and SOC [1.5V=100%; 0.15V=10%] for the preferred marine deep-discharge flooded lead acid battery.

The charge controller should consume minimum power, and should switch at appropriate flooded lead acid or sealed lead acid battery charge voltages. (The Sun-Systems Micro M+ is a preferred device.)

The charge controller should be properly fused and protected from lightning and transient voltages using gas-discharge tubes and metal oxide varistors.

Power from the solar cell should be stored in a “power sink,” or a repository for electrical power. A marine deep-discharge flooded lead acid battery is preferred because of its high capacity, long life, compatibility with the charge controller, and ready availability.

To avoid the problem of acid spills or hydrogen leaks, the marine deep-discharge flooded lead acid battery should be regularly maintained, should never be exposed to charge voltages or currents in excess of its specifications, and should be enclosed in a waterproof, ABS-battery case.

Although many types of electronic equipment can be powered directly from a marine deep-discharge flooded lead acid battery, many cannot. Some laptop computers and radios require higher or lower voltages. To accommodate the varying voltage requirements that are likely to be met in the field, the emergency radio communicator should have an array of individual rechargeable cells, which can quickly be assembled to provide the requisite voltage.

An example of an excellent source of portable power suitable for most radios and most IBM portable computers is a battery of 10 nickel metal hydride cells. Now, individual cells are available in size “D” with capacities around 10 amp-hours each. A battery comprised of 10 such cells has an amazing 100 amp-hours of power at about 13 volts, easily rivaling an automobile battery in power, but in a much smaller package.

Another example of portable power suitable for most Dell portable computers is a battery of 15 nickel metal hydride cells. Now, individual cells are available in size “D” with capacities around 10 amp-hours each. A battery comprised of 15 such cells has an amazing 150 amp-hours of power at about 19.5 volts, exceeding most automobile batteries in power, but in a much smaller package.

The emergency radio communicator will require in the field a means of charging the various Portable Battery Packs assembled from the nickel metal hydride cells. Because the charging characteristics of these batteries are vastly different from flooded-cell lead acid batteries, the solar cell charge controller cannot be used without modification. Also, the need for a quick recharge of the Portable Battery Packs obviates the solar cell.

A rapid charger for the Portable Battery Pack can be constructed by using the marine deep-discharge flooded lead acid battery as a power source, and a charge controller. The charge controller should apply sufficient voltage to the Portable Battery Pack to charge the battery at a rate between 2C and 5C (two to five times to capacity of the battery), and should occasionally interrupt the charging process (for five to ten seconds every two minutes) to allow for sensing of the resting voltage. When the battery reaches Peak Voltage Detect (“PVD”—a voltage drop of 3.0 [symbol] 5.0 millivolts per cell), also know as either “zero-delta V” [“0ΔV”](no change in resting voltage) or “negative-delta V” [“−ΔV”] (a 3.0 [symbol] 5.0 millivolts per cell drop in resting voltage), the charge controller should switch to a C/64 charge rate ( 1/64 of the battery capacity), because the battery has reached its 90-95% “state of charge.” Additionally, the device should have a temperature cutoff probe (“TCO”) set to discontinue charging in the event that the battery reaches 104° F. (40° C.) to prevent damage to the battery. (The Triton Electri-Fly System is a preferred device.)

All DC connections should exhibit extremely low resistance, should be easily detached and re-attached, and should be color coded and polarized to prevent accidental reversed polarity connections. The emergency radio operator should keep at hand a collection of various power cords with a variety of DC connectors on one end, and a uniform DC connector on the other end, to allow powering unexpected devices. The collection of connectors should include alligator clips, banana plugs, bare wires, trailer style connectors, and an assortment of coaxial connectors in various sizes. The uniform DC connector can be a pressure fit device. (The Anderson Power-Pole System is a preferred device.)

Equipment Array of One or More Laptops & Radios

The power system that results from the thoughtful and careful application of these principles is extremely versatile and allows for extensive powering of an array of devices. For example, in the “hot zone” of an emergency situation, the operator may power from this system an array of portable laptop computers from different manufacturers (allowing instantaneous monitoring of transmissions), low voltage lighting, radio equipment, powered audio amplification, phantom-fed microphones, and related test equipment.

Battery Array of Varying Voltages

By arranging a battery of cells in such a way as to have access to the connections between the cells, it is possible to tap into the battery at different points, thereby drawing power from the battery at different voltages, to power the array of equipment where each device may require a different operating voltage.

For example, if the battery consists of 15 nickel metal hydride cells, the total voltage of the battery will be approximately 19.5 volts at a 100% state of Charge. By using a common ground, but instead tapping in at the tenth cell, the same battery will deliver not only 19.5 volts, but also 13 volts. Other tap points would result in differing voltages, with each cell providing 1.3 volts in multiples of 1.3, e.g., 1.3; 2.6; 3.9; 5.2; 6.5; 7.8; 9.1; 10.4; 11.7; 13; 14.3; 15.6; 16.9; 18.2; & 19.5, and etc.

The resulting battery pack should be covered with a material that accomplishes several different functions. First, the material must be strong enough to hold the weight of the battery. It must also be thick enough to prevent shorting of the connections, and it must be waterproof for field use. Also, the material must be thin enough to minimize the additional weight of the cover itself, and must be as thin as possible to minimize heat building that might occur in insulated containers. The cover must have a small zippered (in the alternative recloseable with Velcro™) pocket enclosing the battery itself, another small zippered (or the alternative) pocket for the power connectors, and a third similar pocket for a selection of additional power taps and connectors. Finally, the cover must have a sturdy handle for carrying, and a place to attach a clip, string, or other device to secure the battery during field usage. Ripstop nylon is a preferred material for the cover.

Because an array of different devices will be attached to the battery at different cell-points (to supply the correct voltage), and because the devices draw different amounts of current (e.g., a laptop computer draws more current than an emergency LED lighting device), attention must be given to a strategy to draw current from the individual cells as evenly as possible, to deter failure of the battery due to depletion of individual cells at disparate rates.

The solution is to draw voltages not from a single negative lead at cell 1, but from different cell-points, varied to balance the current draw.

Specifically, under this example, a Dell laptop computer requiring 19.5 volts would be attached to the array at the negative lead of cell number 1, and at the positive lead of cell number 15, the battery thereby supplying 19.5 volts to the Dell laptop computer.

Simultaneously, an IBM laptop computer requiring 13 volts would be attached to the array at the negative lead of cell number 1, and at the positive lead of cell number 10, the battery thereby supplying 13 volts to the IBM laptop computer.

The Dell laptop computer in this example is drawing power from cells 1 [symbol] 15, and the IBM laptop computer in this example is drawing power from cells 1 [symbol] 10. Therefore, cells 1 [symbol] 10 are being drawn down faster than cells 11 [symbol] 15.

Additional equipment should thus be attached to cells 11 [symbol] 15 instead of further burdening cells 1 [symbol] 10.

Simultaneously attached portable lighting equipment requiring, for example, 5.2 volts would be attached to the array, but not necessarily at negative lead 1. Under this example, the operator would select as a negative lead cell-point the juncture between cells 10 & 11, and would select as a positive lead cell-point the juncture between cells 14 & 15, accomplishing the dual tasks of providing the proper 5.2 volts (from 4 cells) and balancing the current draw.

Additional equipment would be attached to the array in a similarly balanced approach, resulting in a portable, solar powered, field regulated, field rechargeable, waterproof, heatproof, transient suppressed, fused, field configurable, balanced current, multiple voltage, power-sink based, included portable battery pack, multiple equipment array, high current capacity emergency radio and attendant equipment power source capable of supplying custom-tailored power to a wide array of field equipment.

The invention claimed is:

1. A method for interoperable radio communications, comprising: a) providing a computer having at least one sound card and at least two sound card channels; b) configuring said at least two sound card channels to receive transmissions from at least two separate radio frequencies; programming said computer to receive transmissions to the sound card channels and further programming said computer to post either sound recording or transcribed voice or data files obtained from said received transmissions via the sound card channels to folders on the computer; and making at least one folder accessible by radio communication to a user operating a radio on one of said frequencies.

2. The method according to claim 1, wherein said user addresses the computer by speech.

3. The method according to claim 1, wherein any message or information posted for receipt may be alerted to the intended recipient by any audible, visual or other alert.

4. The method according to claim 1, wherein said user addresses the computer by speech and said computer has been previously programmed to recognize the user's speech by speech recognition training software.

5. The method according to claim 1, wherein when a user accesses said at least one folder, at least a portion of the contents of the folder is transmitted by the computer to the radio of the user via a radio associated with the computer.

6. The method according to claim 1, wherein when a user accesses said at least one folder, at least a portion of the contents of the folder is transmitted by the computer via software defined radio to the user.

7. The method according to claim 1 wherein at least two users respectively use said at least two frequencies and either can transmit or receive messages from the other, via said computer, on the user's respective frequency.

8. The method according to claim 1 wherein speech addressing of the user also identifies the user to the computer via a speech print of the user unique to the user.

9. The method according to claim 1, wherein at least one user is a user sending weather data to the National Weather Service and wherein said user transmits to said central computer either by voice or data transmission.

10. The method according to claim 1, wherein said user is a robotic user which transmits sensor or other data to said computer.

11. The method according to claim 1, wherein said user is a combination of a human user and a robotic or automated function.

12. The method according to claim 1, wherein the user employs a solar cell having the capacity to replenish 1.5 times the usage of the radio equipment over a 5-7 day time period.

13. The method according to claim 1, wherein said computer is powered by a power package containing a plurality of cells and, depending on the voltage requirement of the user, the device requiring to be powered is attached to the array at the negative lead of the first cell and at the positive lead of the furthest selected adjacent cell in the array to give the desired voltage.

14. The method according to claim 1, wherein said computer is powered by a power package containing 15 nickel metal hydride cells wherein the total voltage is approximately 19.5 volts at a 100% state of charge when the computer is attached to the array at the negative lead of the first cell and at the positive lead of the 15^{th} cell.

15. The method according to claim 13, wherein the power package can be reconfigured by attaching a substitute device requiring lower power to the array at the negative lead of the first cell and at the positive lead of the 10^{th} cell, to supply 13 volts instead of 19.5 volts.

16. The method according to claim 1, wherein said at least two sound card channels are attributable to at least two sound cards.

17. A method for interoperable radio communications including the steps of: a) at least one radio user's transmitting at least one transmission on a first radio frequency to a computer having at least one sound card and at least two sound card channels on one or more sound cards, wherein each of said at least two sound card channels is programmed to receive and/or to transmit from or on at least two separate radio frequencies; b) said radio user's simultaneously or subsequently posting, via the preprogrammed computer, said transmission as either a sound recording or a transcribed voice or data file obtained from the received transmission to a folder on the computer; and c) at least a second radio user's transmitting and/or receiving, on a second radio frequency via a sound card channel, to or from the same or another folder on the same or another computer, to enable said at least two users to transmit and/or receive messages from said computer via said at least two first and second radio frequencies.

18. The method according to claim 15 wherein when the computer folders are periodically replicated on more than one computer by separate radio transmission, each radio user may transmit to the same or a different computer any time data is sent or retrieved.

19. The method according to claim 15 where the user is any of human, robotic, or a combination of human and robotic or other automated equipment.

20. A method of establishing the individual identity of a computer user to a computer, comprising a) programming a computer to recognize the speech of at least one user, followed by b) the addressing of data by the at least one user's speech to and/or from said computer, wherein due to the addressing via speech recognition the computer can distinguish said at least one user from a different user.

21. A method of establishing the identity of a recipient of information, comprising a) programming a computer to recognize the speech of at least one user, followed by b) the addressing of data by the at least one user's speech to and/or from said computer, wherein due to the addressing via speech recognition, the computer can designate the intended recipient of the information.
